(19) United States
(12) Patent Application Publication
(10) Pub. No.: US 2002/0056956 A1
(43) Pub. Date: May 16, 2002

(54) Device for stacking continuous forms

(76) Inventors: Bartelt Hans Steven Mos, Rucphen (NL); Dieter Jakob Piel, Neuss (DE)

Correspondence Address: BLANK ROME COMISKY & MCCAULEY, LLP, 900 17TH STREET, N.W., SUITE 1000, WASHINGTON, DC, 20006, US

(21) Appl. No.: 10/035,437

(22) Filed: Jan. 4, 2002

Related U.S. Application Data
(63) Continuation of application No. PCT/NL00/00477, filed on Jul. 6, 2000.

(30) Foreign Application Priority Data
Jul. 9, 1999 (EP) 99202266.5

(51) Int. Cl. B41L 1/30

(52) U.S. Cl. 270/40

(57) ABSTRACT

A device for stacking continuous forms, in which pressure means are present, which comprise a pressure component which can move in a reciprocating manner towards and away from a vertically extending support surface, for pressing the continuous forms against the support surface, the device furthermore comprising conveyor means for conveying the continuous forms into the storage space.

This is a continuation application of PCT/NL00/00477 filed Jul. 06, 2000, which PCT application claims priority of European patent application number 99202266.5 filed Jul. 09, 1999, both herein incorporated by reference.

### FIELD OF THE INVENTION

The invention relates to a device for stacking continuous forms, and to a method for operating a device of this nature.

### BACKGROUND OF THE INVENTION

Continuous forms are intended to mean strip-like, endless material in sheet form, in particular paper, which comprises a transverse fold and/or perforation line at regular intervals. The material between two successive folds/perforations is defined as a form or a form length. The continuous forms are often folded in zig-zag form at the location of the folds/perforation lines after manufacture, so as to form a stack of continuous forms. Therefore, a strip of continuous forms which comes off a stack of this nature will have a number of “natural” folded edges which delimit the forms.

Continuous forms of this nature are used, for example, for a computer printer to print data. To this end, the continuous forms are conveyed from the stack in which they are delivered into a printer as a continuous strip and are successively printed in the printer. Then, the strip of printed continuous forms is delivered out of the printer. The free sides of the continuous forms (i.e. the sides which are not joined to adjacent forms) are generally provided with small conveying holes which are arranged at regular intervals and can interact with projections of conveyor wheels or conveyor belts which are arranged in the printer, in order to convey the continuous forms through the printer.

In order to prevent an uncontrolled pile-up of printed continuous forms, it is known to roll up the continuous forms into a continuous strip after they leave the printer, in a step which is linked to the printing process. However, this has the drawback that it is difficult to gain access to the separate printed forms. It is therefore advantageous for the printed forms to be stacked in zig-zag form after they have been processed, forming a stack whose surface area is the same size as that of one form.

By the printing action, the original folds of the continuous forms are “unfolded”. When, after printing, the continuous forms are refolded to obtain a zig-zag folded stack again, the folds will be less sharp than was the case before the printing took place, so that after the printing operation the stack takes up a considerably larger volume than previously.

In both EP-A-0 412 437 and in EP-A-0 583 826, it is attempted to solve the above problem by providing a device which comprises a horizontal base plate onto which the continuous forms are fed in zig-zag form from above, so that a stack is formed. Pressure means are placed on the two mutually opposite sides of the stack which are defined by the folded edges of the continuous forms.

In EP-A-0 412 437, positioning means are present that are movable towards the form stack, therewith pressing against the edges of the stacked forms in order to hold the forms of the stack. Further, air blowers are present for directing the forms for proper folding on the stack. As will be explained below, means for directing the forms such as said air blowers are not required in the device according to the invention; therefore the device according to the invention is preferably devoid of air blowers.

The pressure means in EP-A-0 583 826 comprise a strip of flexible material which strikes against the folded edges of the continuous forms in a continuous downwards movement, with the result that pressure is exerted on the stack each time. When the flexible strip comes into contact with the continuous forms, the movement in the downwards direction is continued, with the result that the flexible strip is bent over and scrapes along the stack of paper, which may cause damage to the stacked paper.

A further problem with the abovementioned device is that movement of the pressure strips has to be accurately synchronized with the feed rate of the continuous forms. In the event of inaccurate synchronization, the flexible pressure strip may prevent the continuous forms from being correctly deposited on the stack, with a risk of the continuous forms being damaged or even torn apart.

### SUMMARY OF THE INVENTION

The object of the invention is to eliminate the abovementioned problems, and to this end a device for stacking continuous forms is provided, comprising

a storage space for the continuous forms, with a feed opening and a support surface, against which continuous forms can be stacked,

pressure means for pressing, within storage space, the continuous forms against the support surface, so as to form a stack, the pressure means comprising

a pressure component which can move in a reciprocating manner towards and away from the support surface, for pressing the continuous forms against the support surface,

conveyor means for conveying the continuous forms into the storage space, wherein the support surface extends in vertical direction.

Pressure means of this nature ensure that the continuous forms are pressed correctly against the support surface, forming a condense stack without the forms being damaged. After the pressure has been applied to the continuous forms, the pressure means will be moved back away from their support surface. A synchronization problem does not arise, since the device itself comprises conveyor means, so that the operation of the conveyor means and the pressure means can be matched to one another.

In contrast to the devices of the art, the support surface extends in vertical direction. This means that the support surface is positioned at an angle with the horizontal. It has been found that, especially when the said angle, seen from the side of the support surface against which the forms are stacked, is between 90° and 120°, preferably between 95° and 110° and most preferably between 100° and 105°, forms can be conveyed into the storage space without the need for any additional positioning means for correctly introducing the continuous forms into the storage space. The forms are thus stacked in a substantial vertical state, allowing convenient further processing of the stack, such as packaging etc.

Preferred embodiments of the device according to the invention are given in claims 2-11.

Methods for operating the device are given in claims 12-17.

### BRIEF DESCRIPTION OF THE DRAWINGS

The invention will now be explained in more detail with reference to the appended drawing, in which:

FIG. 1 shows a cross section through a preferred embodiment of the device according to the invention;

FIGS. 2a, b, c, d and e diagrammatically show the operation of a plurality of exemplary embodiments of the device according to the invention.

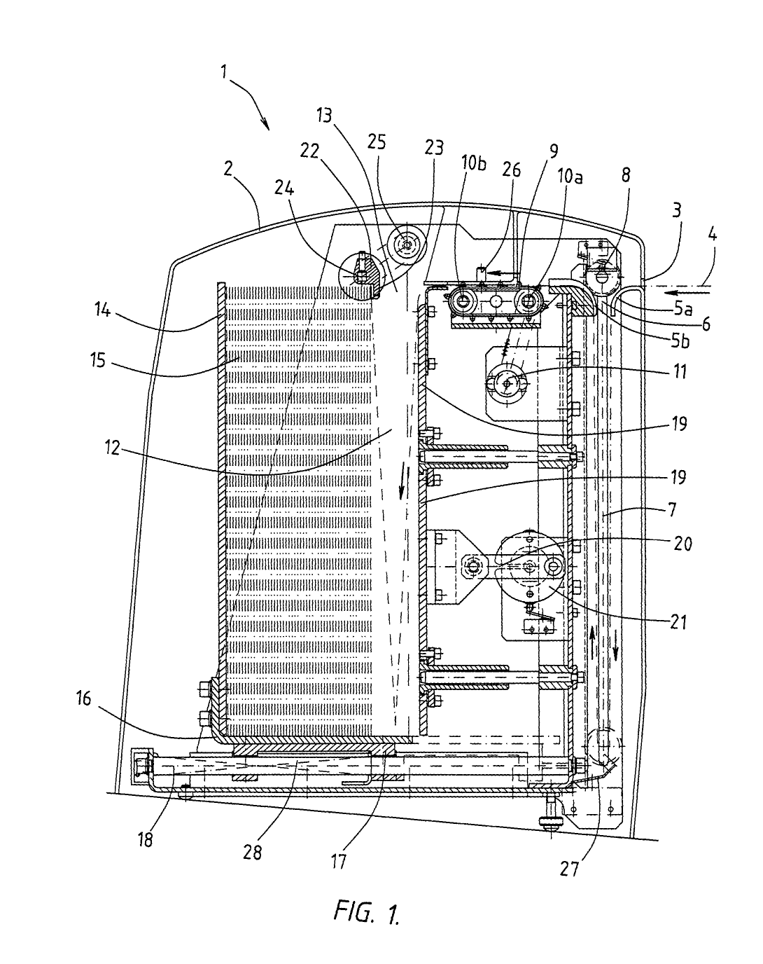

In FIG. 1, 1 denotes a device according to the invention, 2 denotes a housing and 3 denotes an entry opening, through which continuous forms 4 can be guided into the device in the unfolded state. The direction in which the forms are conveyed is indicated by arrows. Directly after the entry opening, there is a buffer space 7, with a slot-like buffer entry 6 which is delimited by two downwardly curved guide components 5A and 5B, along which the introduced continuous forms are guided into and out of the buffer space. In the buffer space, there is a buffer shaft 8, which is positioned substantially at right angles to the direction in which it is intended to convey the continuous forms and which can move vertically between a highest position and a lowest position. In the situation depicted, shaft 8 is in its highest position. 9 denotes an endless conveyor belt which is provided with projections and is guided around wheels 10a and 10b. In the situation illustrated, wheel 10a is driven by a motor 11. The projections are situated at standardised distances from one another, i.e. the distances between the projections, as well as the diameter of these projections, respectively correspond to the distance between and the diameter of the small conveying holes in the free sides of the continuous forms. 12 denotes a storage space with a feed opening 13 and a support surface 14. A stack 15 of continuous forms is situated against the support surface 14. The support surface is mounted on a base plate 16, which base plate is attached to a carriage 17 which can be moved along a guide 18. On the side opposite to the support surface 14, the storage space is delimited by a pressure surface 19 which, via a crankshaft 20, is driven by motor 21. In the vicinity of the entry opening 13, there is a clamping component 22, which comprises a strip-like component 23, by means of which, in the situation illustrated, stack 15 is held against support surface 14. Clamping component 22 is positioned so that is can rotate about a shaft 24; it is possible to eliminate the clamping action on the stack by rotating clamping component 22 a quarter turn in the anticlockwise direction. To this end, clamping component 22 is connected to a motor 25.

Above the drive belt 9, there is an optical reader 26 for detecting a conveyed length of continuous forms.

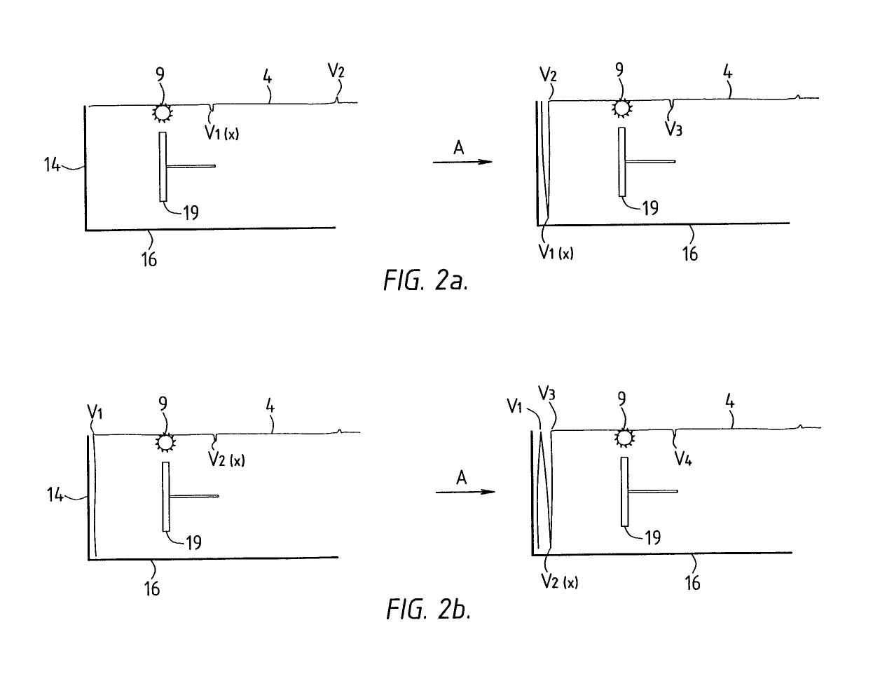

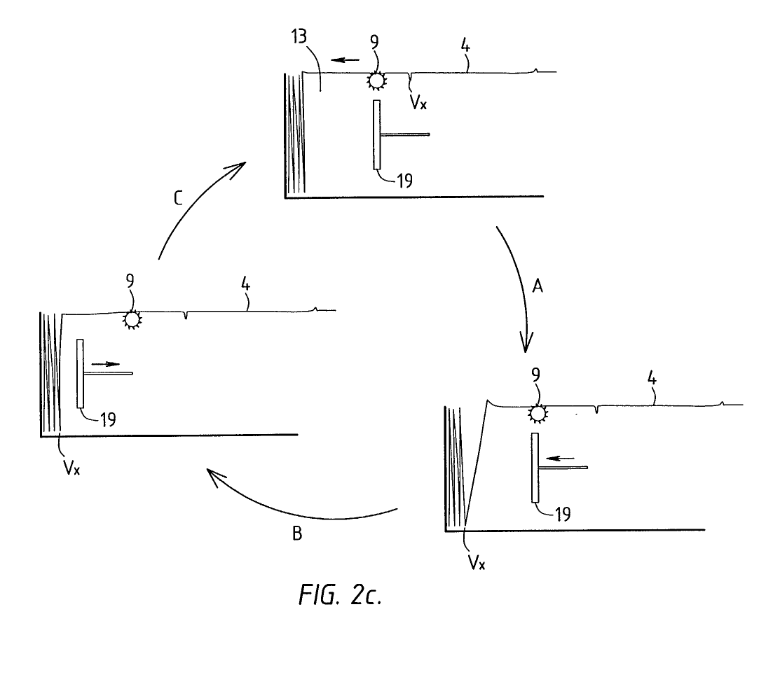

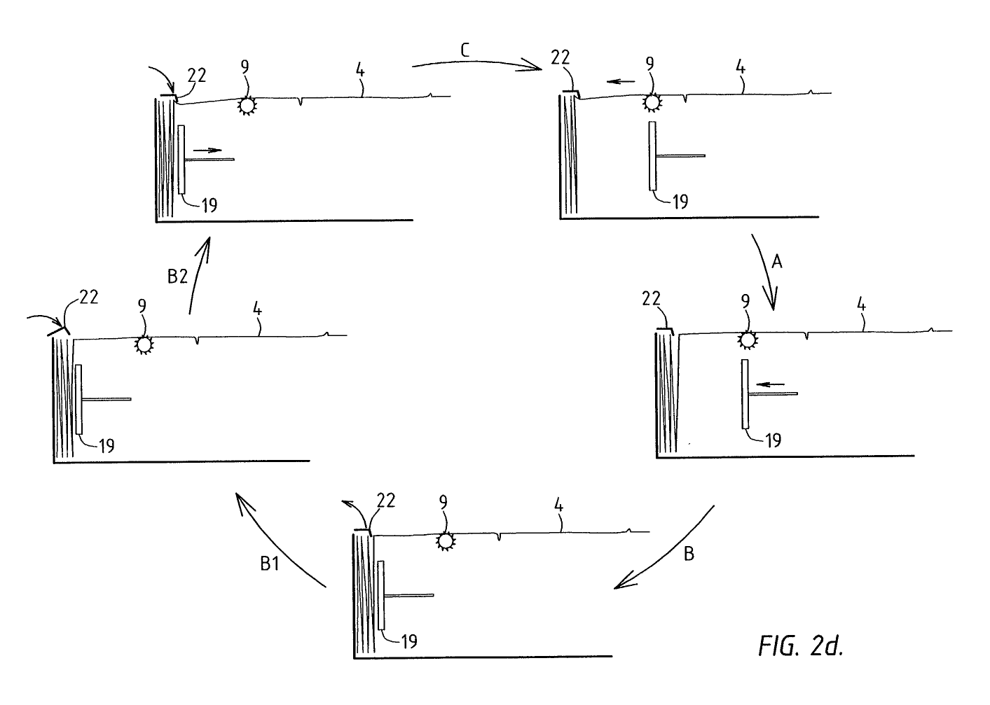

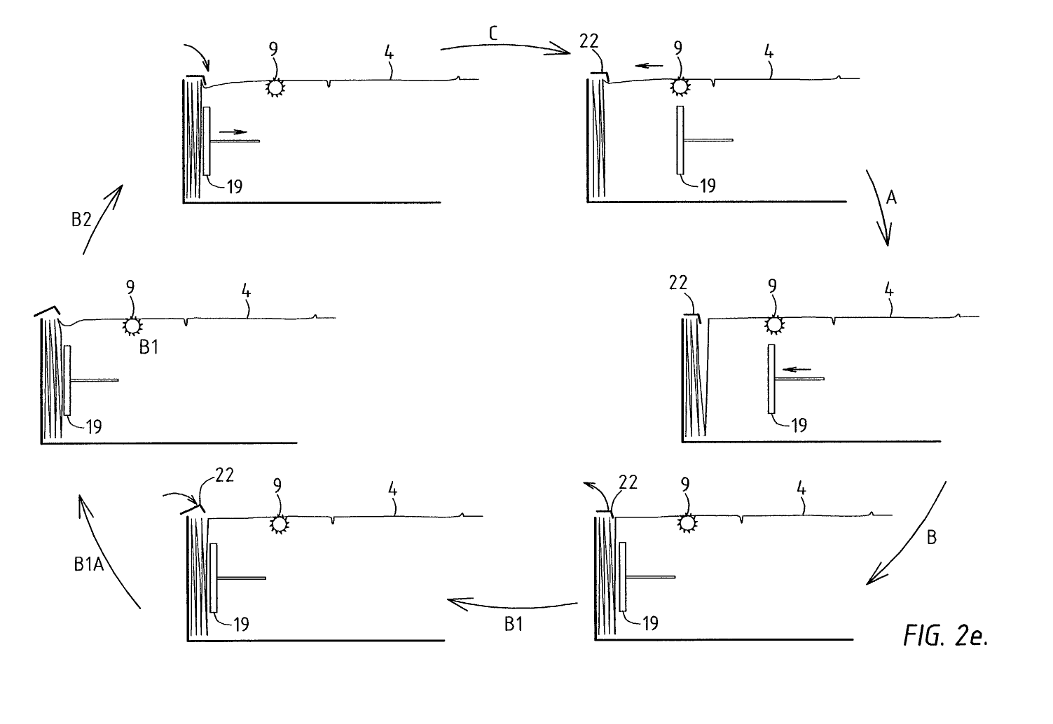

A first detailed explanation of how the device according to the invention operates will be given with reference to FIG. 2, which provides a very diagrammatic illustration of the device 1. The components which correspond to those shown in FIG. 1 are given identical reference numerals.

Firstly, the free end of the first continuous form of the length of connected forms is attached to support surface 14 in the vicinity of the feed opening (cf. FIG. 2A), advantageously at a distance from the base plate 16 which substantially corresponds to one form length. Since the continuous forms 4 are in their original state generally stacked in zig-zag form, each form is joined to the following and the preceding form via a fold V in each case. Said folds are oppositely directed, as illustrated in the form feed path 4 by a V shape or an inverted V shape. In order, during stacking, to utilize the natural folds between the forms, the natural fold V1 between the first and second continuous forms is, as illustrated, preferably oriented as a V shape, rather than an inverted V shape, i.e. the said fold faces towards base plate 16. As a result, the second form is inclined to fold back upwards towards the feed opening 13. If the fold between the first and second forms is oriented as an inverted V shape, the first form of the strip is positioned fully against the support surface 14, i.e. with the free end in the vicinity of base plate 16 (cf. FIG. 2B). The fold between the first and second forms has the desired orientation and is situated a distance of one form length from the base plate 16. Once a strip of continuous forms is situated inside the device, as indicated above, during operation of the device, as first step A) (cf. FIGS. 2A, 2B and 2C), a length comprising two continuous forms is conveyed into the storage space 12, for example by the conveyor belt, which in these figures is diagrammatically denoted by 9, executing a defined number of revolutions, for example. To this end, the number of small conveyor holes in the form can be counted by the optical measuring device 26. Conveying two continuous forms, referred to below as “conveyed length”, two forms are deposited in the storage space, so that the original V-shaped fold (denoted by X) is again formed between the forms. The said fold is then situated in the bottom of the storage space, in the vicinity of base plate 16. Then, the conveying is interrupted and two forms which have been deposited in the storage space, in step B, are pressed against the support surface, or against the stack which is already situated against the support surface, as a result of the pressure plate 19 moving towards the support surface.

After it has exerted the required pressure, the pressure surface will be moved away from the support surface (step C). Now, the two forms which were conveyed into the storage space in step A) have been pressed against the stack and are part of the stack. The retraction of the pressure surface again produces sufficient free space in the storage space for the next conveyed length of continuous forms to be conveyed into the storage space (in a following step A).

The result is a stack in which the V-shaped folds of the forms define that side of the stack which is in the vicinity of the base plate, and the inverted V-shaped folds define the opposite, upwardly directed side.

The use of clamping means is described in FIG. 2d. As described in FIG. 1, the clamping component is used to hold the stack clamped against the pressure surface. This is because it has been found that, due to the forms being printed or otherwise processed as a straight length in the unfolded state, the original folds no

longer possess their original sharpness, with the result that the forms, once printed, have a certain tendency to spring back into the storage space, thus taking up room in the free space inside the storage space, which may make it difficult to deposit a new conveyed length of continuous forms. The clamping means are diagrammatically depicted in FIG. 2d by 22. During the conveying step A), the clamping component 22 is situated in a position in which the stack is clamped against the support surface. During the exertion of pressure in step B), the clamping component is released, and it is then once again clamped in place so as to incorporate the continuous forms conveyed in the preceding step A). It has been found that, if the clamping component is again clamped onto the stack during the exertion of pressure, it is easy to bring in the continuous forms which have just been conveyed. If the clamping component is clamped in place at a later time, for example after the pressure surface has been retracted, there is a risk of the last two forms springing back slightly, making it difficult for the clamping component to grip these forms. However, it is also quite possible to design the clamping component in such a manner that forms which have sprung back slightly are taken hold of and clamped in place when the pressure surface has already moved away from the stack.

After the clamping component has again been clamped in place, the pressure component is moved away from the support surface, so that sufficient free space for the next conveyed length of continuous forms to be deposited is again formed in the storage space.

In order to improve still further the action of the clamping component on the conveyed length which was deposited and pressed against the stack last, after the clamping component has been released (step B1 in FIG. 2e), the front section, as seen in the direction in which it is intended to convey the forms, of the following conveyed length is conveyed in the direction of the feed opening (step B11). As a result, the fold between the preceding conveyed length and the following conveyed length which is still to be conveyed is already moved towards the feed opening of the storage space, with the result that the said fold is pressed against the stack and is positioned optimally for the clamping means to act on it. In a following step, as has been explained above, the clamping component is clamped fixedly in place and, in a following step C), the pressure plate is moved away from the stack. In the following step A), the remaining length of the conveyed length is conveyed.

Preferably, the front section, which is conveyed in step B1A), amounts to at most 3% of the conveyed length, i.e. at most 6% of the length of one form.

In the following text, the various components will be explained separately in light of the method.

The pressure surface may be a solid surface, but may also, for example, comprise a perforated plate or be designed as a number of strips positioned at a distance from one another. Advantageously, the pressure surface covers at least 30% of the entire surface of one continuous form, in order to provide for sufficient pressing and therefore stacking action for forming a condense stack of the forms. Preferably, the pressure surface therefore covers at least 50%, more preferably at least 75% of the entire surface of one continuous form. Most preferably, the pressure surface covers substantially the entire surface of one continuous form.

Preferably, the pressure surface is positioned such that during pressing the stack of forms, the pressure surface extends from the centre of the forms in the direction of the edges thereof. This means that in such a case, when the pressure surface does not cover the entire surface of the form, said surface will not necessarily extend to the edges of said form.

In this context, enclosed area is understood to mean the area which is enclosed by the periphery of the pressure surface. This means that, for example in the case where the pressure surface is a perforated plate, the perforations are included in the area. However, it is also possible for pressure to be applied to only certain locations on the stack; in this case, the clamping component does not have to be in plate form, but may, for example, comprise one or more ram elements. If the device is provided with one or more clamping components, as referred to above, it will be clear that the surface of the continuous form on which the clamping component acts does not have to be covered by the pressure surface. In the situation illustrated in FIG. 1, the top edge of the stack, i.e. that side of the stack which lies opposite to the base plate 16, will not come into contact with the pressure surface, but will be free for the pressure strip 23 of the clamping component 22 to act on.

Advantageously, the support surface can be displaced in the direction perpendicular to the surface and away from the pressure component. A support surface which can be displaced in this way has the advantage that the free space in the storage space can be kept substantially constant, irrespective of the thickness of the stack which is already present in the storage space. This can e.g. be achieved by placing the support plate on a guide, via a carriage, so that the carriage can be displaced away from the pressure component, counter to a spring pressure. To this end, guide 18 incorporates a compression spring 28 which acts on carriage 17. During each pressure-exerting movement carried out by pressure surface 19, the stack is pressed slightly along the guide, counter to the spring pressure. When the pressure surface moves back, the clamping component 22 may also, for example, function as a stop, thus stopping further movement of the stack in the direction of the pressure surface. It is also possible to arrange a stop in some other way known to the person skilled in the art. The presence of a stop is advantageous in order to provide a substantially constant free space in the storage space, for accommodating a following conveyed length of continuous forms.

To prevent the conveyor means from conveying a following conveyed length into the storage space if the feed from an upstream processing device, such as a printer, is insufficient, the device preferably comprises buffer means for holding a buffer length of continuous forms, which buffer means are connected upstream of the conveyor means. Preferably, the buffer length constitutes a length of two continuous forms or more. Advantageously, the conveyor means are then controlled in such a manner that step A) is carried out once a conveyed length is situated in the buffer space, and that the cycle is interrupted after step C) when the length of the continuous forms in the buffer space is less than one conveyed length. If the feed to the device is slower than the stacking operation, in this way the following conveyed length will only be conveyed when the desired conveyed length is again present in the buffer space. Sufficient methods are known in the field of measurement and control engineering to achieve the abovementioned control method. For example, an optical measurement instrument which measures the number of small conveyor holes in the continuous forms may be used to measure the desired conveyed length; after the desired length has been conveyed, the conveyor belt is switched off. A similar measuring device may be positioned in the buffer space in order to measure the length of forms present therein. As an alternative example, in the case illustrated in FIG. 1, a shaft 8 is positioned in the buffer space, and the continuous forms are guided through beneath this shaft. When a buffer length of two forms is situated in the buffer space, the shaft 8 will be in its lowest position, where it will operate a switch 27, thus actuating motor 11 and conveying a conveyed length into the storage space. As a result of the continuous forms being conveyed out of the buffer space, shaft 8 will be moved upwards, with the result that switch 27 is switched off and the actuation of motor 11 is stopped. When buffer space 7 is empty, the shaft 8 will be situated in its highest position. As soon as one complete buffer length is again situated in the buffer space, shaft 8 will move downwards and depress switch 27 again, with the result that a following conveyed length will be conveyed. If the feed rate of continuous forms is sufficient, shaft 8 will be situated constantly in the lowest position, with the result that motor 11, after step C), will immediately convey the following conveyed length into the open space.

The conveyor means preferably, as indicated above, comprise a conveyor wheel or conveyor belt which is provided with projections. Since continuous forms are generally provided with small conveyor holes on both free sides, the device preferably comprises two sets of conveyor means, so that the forms are conveyed, via the small conveyor holes, on both free sides of the forms.

It is also possible for the conveyor means to act on only one side of the continuous forms, in which case the device may comprise a non-driven guide on the other side of the continuous forms.

As indicated above, the device is preferably arranged in such a manner that the forms are stacked substantially in the vertical state. In this way, the conveyed continuous forms will be moved into the free space in the storage space as a result of gravity, so that there is no need for any additional means for correctly introducing continuous forms into the storage space. In this connection, it has proven extremely advantageous for the device to be positioned at a slight angle to the horizontal, as illustrated in FIG. 1. As a result, the stack is held optimally in place against the support surface 14 and the continuous forms are deposited optimally in the storage space. The angle between the side of the support surface 14, against which the forms are stacked, and the horizontal is preferably between 95° and 110°, more preferably between 100° and 105°.

Advantageously, the device furthermore comprises positioning means for holding the forms on the stack. As has already been mentioned above, the continuous forms which have just been stacked may be inclined to spring back into the free space in the storage space. In order to counteract such a situation, it is advantageous for one or more strip-like components to be placed against the stack immediately after pressure has been exerted on the stack or just after the pressure component has been retracted, these means being brought into engagement with the last forms which were added to the stack. The clamping component discussed above is one example of such means. It is also possible to choose to provide an additional clamping component instead of the clamping component or in addition to the clamping component. This additional component may, for example, comprise a thin, flexible strip, made from metal or plastic for example, which is pushed over the said stack e.g. in a wiping movement, after one conveyed length has been added to the stack. A component of this nature may, for example, be situated in the vicinity of the base plate or between the base plate and the feed opening.

Advantageously, the device is designed in such a manner that it is suitable for stacking a plurality of formats of form. As described above, the forms are in each case stacked by form length. By reducing the distance between the entry opening 13 and the base plate 16, it is possible to stack strips of continuous forms with correspondingly shorter form lengths. To this end, adjustment means may be arranged between the base plate 16 and carriage 17, making it possible to adjust the distance between the carriage and the base plate.

In a special embodiment, the pressure surface 19 comprises two or more separate plates that are slidingly arranged to one another; when forms of a large format are stacked, said plates may be slided from one another therewith creating a large pressure surface area. With smaller forms, the plates may be slided more towards each other, creating the required smaller pressure surface area. Such plates may be designed with finger-shaped extensions that may slide along each other when the plates are moved together obtaining a flush surface.

Advantageously, the pressure surface 19 comprises an upper and a lower plate, that may slide to and from each other in a plane, parallel to that of the support surface 14. The upper plate my be in a fixed position in the device, whereas the lower plate may be coupled to the base plate 16. When smaller forms are to be stacked, the base plate 16 and the lower plate are elevated, the lower plate sliding towards or into the upper plate, creating the required pressure surface. The pressure surface of the upper and lower plates are preferably in the same plane.

Preferably, the base plate can accommodate, or is part of a specially designed form container to receive the stacked forms. Such a form container can be designed such that it can accommodate stacked forms of a specific standard length, e.g. 11 inch. When other forms of a different length are to be stacked, the form container can be exchanged for another form container, designed to accommodate these other forms.

In a preferred embodiment, the form container comprises identification means that correspond to the form length that can be accommodated in the said container. In that case, the device according to the invention comprises detection means, which can detect said identification means and which can direct the conveyor means of the device to transport the proper transport length, corresponding to the form length to be accommodated in the container. For example, the identification of the form container mounted in the device is read or entered into a data processing system that directs the proper transport of the forms. In such a way, a particular form container, corresponding to a certain form length, can be identified by reading means, such as an optical sensor. As a result of data processing, the optical reader 26 is adapted to read the proper transport length of the new forms and to direct the corresponding numbers of revolutions of the conveyor belt. The exchange of a mounted form container by another form container for other form length can be registered by the detection means of the device, resulting in the adjustment of the proper transport of the new forms.

The device may also be suitable for stacking forms of different widths. It will be obvious to the person skilled in the art to dimension the device in such a manner that the device is able to convey and stack a desired maximum form width. By, for example, designing wheels 10A and 10B to be movable in the direction of their axis of rotation, it is also possible to convey and stack forms of reduced width.

However, it is also possible, if continuous forms without perforations are used, to provide the device with two rolls which bear against one another instead of a driven belt with projections, at least one of which rolls is driven and between which rolls the forms are guided and conveyed.

It will be clear to the person skilled in the art that the device illustrated in the figures represents only one embodiment of the invention and that substantial variations are possible within the context of the invention without departing from the scope of the invention as defined by the appended claims.

What is claimed is

1. Device for stacking continuous forms, comprising
a storage space for the continuous forms, with a feed opening and a support surface against which continuous forms can be stacked,
pressure means for pressing, within the storage space, the continuous forms against the support surface, so as to form a stack, the pressure means comprising
a pressure component which can move in a reciprocating manner towards and away from the support surface, for pressing the continuous forms against the support surface,
conveyor means for conveying the continuous forms into the storage space, wherein the support surface extends in vertical direction.

2. Device according to claim 1, wherein the support surface and the horizontal enclose an angle between 90°-120°, preferably between 95° and 110°, most preferably between 100° and 105°.

3. Device according to claim 1, wherein the pressure surface encloses an area covering at least 30% of the entire surface of a continuous form, preferably at least 50%, more preferably at least 75% and most preferably substantially the entire surface of the continuous form.

4. Device according to claim 1, wherein the support surface can be displaced in a direction perpendicular to the surface and away from the pressure component.

5. Device according to claim 1, wherein the device comprises buffer means which are connected upstream of the conveyor means, for accommodating a buffer length of continuous forms.

6. Device according to claim 1, wherein the device furthermore comprises positioning means for holding the forms on the stack.

7. Device according to claim 1, wherein the device comprises a clamping component, for clamping the stack of continuous forms which is situated inside the storage space at least temporarily against the support surface.

8. Device according to claim 7, wherein the clamping component is designed to clamp the stack of continuous forms at the location of one side, formed by fold seams, of the stack.

9. Device according to claim 7, wherein the clamping component comprises a strip-like component which can be made to interact with the stack of paper so as to provide a clamping action.

10. Device according to claim 7, wherein the clamping component is situated in the vicinity of the feed opening of the storage space.

11. Device according to claim 1, wherein the device furthermore comprises a control assembly which is designed to control one or more of the conveyor means, the pressure means and, if present, the clamping means.

12. Method for operating a device according to claim 1, comprising the repeated execution of at least the following successive steps:
A) conveying a conveyed length of the size of two continuous forms, and depositing this length, in a folded V shape, in the storage space, the fold being situated at the location of the transition between the said forms,
B) pressing the forms against the support surface or against the stack which is already situated against the support surface, said support surface extending in vertical direction, by moving the pressure component towards the support surface,
C) moving the pressure component away from the support surface.

13. Method according to claim 12 for operating a device according to claim 7, wherein the clamping component, during steps A), B) and C), is held in a position in which it clamps the stack against the support surface, the following steps also being carried out between step B and C:
B1 releasing the clamping component;
B2 clamping the clamping component again so as to incorporate the continuous forms conveyed in the preceding step A).

14. Method according to claim 13, wherein, after step B1, the front section, as seen in the intended direction for conveying the forms, of the following conveyed length is conveyed towards the feed opening, after which the clamping component, in step B2, is clamped so as to incorporate the said section, forming a fold (V) between the previous, already stacked form and the said section, at the location of the transition between the form stacked last, which contains the said section;
during step A, the remaining length of the said conveyed length is conveyed and deposited in the storage space.

15. Method according to claim 12 for operating a device according to of claim 7, wherein, during the period between the beginning of step C) and the beginning of step A), the positioning means are made to interact with the last form added to the stack, while substantially preventing at least said form from becoming detached from the stack.

16. Method according to claim 14, wherein the front section makes up at most 3% of the conveyed length.

17. Method according to claims 12, wherein the conveyor means are controlled in such a manner that step A) is carried out once a conveyed length is situated in the buffer space, and in that the cycle is interrupted after step C) when the length of the continuous forms in the buffer space is less than one conveyed length.
